(19) United States
(12) Patent Application Publication
(10) Pub. No.: US 2006/0253850 A1
(43) Pub. Date: Nov. 9, 2006

(54) Method, system and computer program program product for evaluating download performance of web pages

(76) Inventors: Giorgio Bruno, Torino (IT); Davide Mamino, Torino (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/554,638

(22) PCT Filed: Apr. 30, 2003
(86) PCT No.: PCT/EP03/04522

§ 371 Date: Oct. 27, 2005

(51) Int. Cl. G06F 9/44

(52) U.S. Cl. 717/173

(57) ABSTRACT

Download performance parameters of web pages accessible via a network are evaluated by providing at least one model for predicting a set of download performance parameters for the web pages as a function of a respective set of input parameters. The at least one model includes at least one optimisation parameter. A set of sample web pages is defined and the set of download performance parameters for the sample web pages are both measured and evaluated on the basis of the model for different values of the at least one optimisation parameter. An error indicative of the difference between the download performance parameters for the sample web pages as measured and as evaluated on the basis of the model, respectively, is defined and an optimised model is selected including a value of the least one optimisation parameter minimising the error or reducing it below a predetermined value. Download performance parameters for any selected set of pages accessible through the network can then be evaluated without interfering with operation of the network on the basis of the optimised model.

### FIELD OF THE INVENTION

The present invention relates to techniques for evaluating download performance of web pages, such as times involved in downloading web pages.

The invention was developed by paying specific attention to the possible application to mobile telecommunications networks such as GPRS (General Packet Radio Service) and UMTS (Universal Mobile Telecommunications System) networks. Reference to this preferred field of application is not to be construed as intended to limit the scope of applicability of the invention.

### DESCRIPTION OF THE RELATED ART

Download times of web pages in networks such as GPRS and UMTS networks are affected by a number of factors. In addition to network performance, the characteristics of each web page, such as the number and the dimensions of the objects comprised on the page, and the browser type used for downloading are other factors that come into play in determining download performance of web pages.

A number of techniques are already available with Internet service providers (ISPs) or content providers (CPs) in order to verify in a non-intrusive way (essentially by way of simulation) the expected performance of services offered to clients.

For instance, the NetForecast Report 5055 entitled “Understanding Web Performance” by T. Sevcik and J. Bartlett, which is an expanded version of an article with the same title first published in Business Communications Review, October 2001, includes a review of commercial products adapted for determining download times of certain web pages. A definition is also provided of certain parameters that can be adapted to those commercial tools in such a way to permit simulation of download times.

A basic disadvantage of such prior art techniques lies in that they not take into account the role played by certain variables such as:
the type of browser used for downloading,
the types of web pages considered,
the specific performance level of certain network services being used, for instance in terms of available bit rate and/or latency.

In fact, these variables are essential in determining the response time of a network such as a GPRS or UMTS network to the request for a certain page to be downloaded, indicated throughout this document as web pages.

Furthermore, such prior art techniques fail to take into account the relationship existing between notional channel capacity available in terms of bit/s and the payload capacity actually available.

### OBJECT AND SUMMARY OF INVENTION

The object of the present invention is thus to provide a technique for predicting download times that may lead to accurate results and that also lends itself to be adapted to the specific characteristics of the services provided by a determined service and/or contents provider.

According to the present invention, such an object is achieved by means of a method having the features set forth in the claims that follow. The invention also relates to a corresponding system as well as to a computer program product directly loadable in the memory of a computer and including software code portions for performing the method of the invention when the product is run on a computer.

A preferred embodiment of the invention evaluates download performance parameters of web pages accessible via a network by providing at least one model for predicting a set of download performance parameters for said web pages as a function of a respective set of input parameters. The at least one model includes at least one optimisation parameter (λ).

Such a model may typically comprise a module for evaluating the sum of:
at least one first factor determined analytically on the basis of network and web page parameters, and
a second factor being a function, preferably of the hyperbolic type, of an optimisation parameter.

A set of sample web pages is defined and said set of download performance parameters for the sample web pages are both measured and evaluated on the basis of the model for different values of the at least one optimisation parameter. An error indicative of the difference between the download performance parameters for the sample web pages as measured and as evaluated on the basis of said model, respectively, is defined and an optimised model is selected including a value of the least one optimisation parameter minimising the error or reducing it below a predetermined value. Download performance parameters for any selected set of pages accessible through the network (N) can then be evaluated without interfering with operation of the network on the basis of the optimised model. This is done (in a non-intrusive manner, i.e. without interfering with operation of the network) by way of prediction on the basis of the selected model.

Preferably, the set of download performance parameters includes at least one parameter selected from the group consisting of download time for a given web page and an efficiency index indicative of how said given web page exploits the capacity of the network.

Still preferably, the prediction model is based on at least one parameter selected out of the group consisting of the throughput of the network, the round trip time (RTT) of the network, and at least one of the type and dimension of each object included in the web pages considered.

In a particularly preferred embodiment of the invention, the model corresponds to the relationship:

$$t = ( \frac{nd}{b} ) + ( \frac{nh}{b} + 2 l + \frac{( n - 1 ) l}{λ} )$$

where t is the total download time of the page, n is the number of objects therein, d is the average size of these objects, b is the throughput of the downstream link (downlink), h is the dimension of the HTTP headers, l is the network RTT and λ is a free parameter to be optimised, namely the parameter whole value identifies the “optimum” model used for evaluating download performance prediction within a plurality of available models corresponding to the general relationship reproduced above.

Specifically, with the technique described herein, the response times to be expected during downloading can be accurately simulated for each service provider or contents provider without interfering with operation of the network. Additionally, an efficiency index can be defined representative of the amount each web page effectively exploits the capacity of the respective network.

The solution described herein gives rise to an architecture and an arrangement that permit both the download times and the efficiency index related to a certain web page to be predicted starting exclusively from the number and dimensions of the objects comprised on the web page in question.

The main advantage of such an architecture lies in that it permits the download times and the efficiency index to be evaluated (i.e. estimated) for a large number of pages based on an optimised model identified via measurements carried out on a relatively small set of sample pages.

An extensive database can thus be rapidly created which is adapted for generating statistics related to the typical surfing speed as perceived by the user of a network such as GPRS/UMTS networks.

In the presently preferred embodiment, the architecture in question includes essentially two categories or groups of elements, namely:
those elements adapted for carrying out “in the field” measurements on the network (GPRS and/or UMTS for instance) with reference to a set of sample pages, thereby permitting identification of a corresponding optimum model, and
those elements that exploit the model thus identified for evaluating purposes i.e. for generating predictions.

### BRIEF DESCRIPTION OF THE ENCLOSED DRAWINGS

The invention will now be described, by way of example only, by referring to the enclosed figures of drawing, wherein

FIG. 1 is a block diagram of architecture for determining model parameters related to downloading web pages in a network such as a GPRS or UMTS,

FIG. 2 is a block diagram of architecture for predicting download times,

FIG. 3 is a flow-chart representing in-the-field measurements and calculation of model parameters, and

FIG. 4 is flow-chart representing the process of estimating download parameters.

### DETAILED DESCRIPTION OF A PREFERRED EMBODIMENT OF THE INVENTION

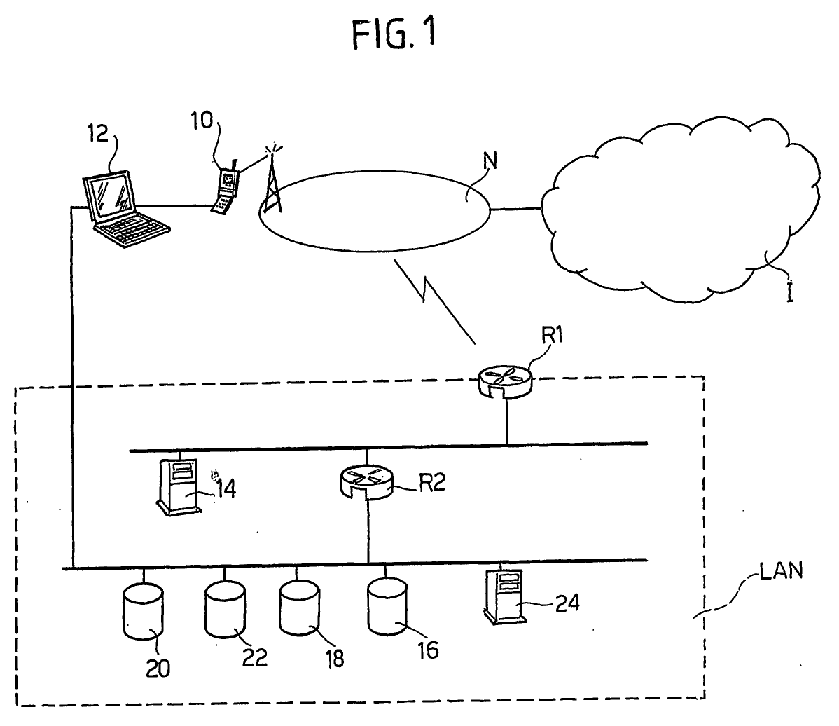

In the diagram of FIG. 1, reference I generally denotes a wide area network such as the Internet, while reference N represents a network, such as a mobile telecommunications network, adapted for providing access to the network I. Exemplary of the network N are, for instance, a GPRS or a UMTS network.

Reference 10 denotes a mobile terminal such as a mobile GPRS/UMTS terminal used primarily as means for conveying data (that is essentially as a modem).

Reference 12 is a processing unit such as a computer configured for in the field measurements. The processing unit 12 is typically a personal computer (PC) such as a “laptop” portable computer adapted to be connected to the mobile terminal 10 to access the Internet I via the network N.

The unit 12 is configured (in a manner known per se) in order to perform a set of measurements including:
throughput measurement,
RTT (round trip time),
download times of selected web pages.

Reference 14 denotes a server terminal facility comprised by one or more servers adapted to be accessed via the Internet and containing reference files used for carrying out measurements of the network parameters. Those files may be comprised e.g. of HTML pages with given formats and sizes.

Connection of the reference server(s) to the network N and to the databases associated therewith (to be described in greater detail in the following) takes place via respective routers designated R1 and R2.

The throughput measurement tool provided in the computer 12 is adapted to measure throughput by downloading corresponding files from the reference server: typically, this may be a HTTP client downloading a single HTML file. The results are stored by writing them as database items in a measurement database 16.

Similarly, the RTT measurement tool installed in the computer 12 carries out RTT measurements towards the reference server(s) 14. Typically, RTT is measured by using a method similar to the method used by the PING command in operating systems (OS). The results are again stored as items in the database 16.

Reference 18 denotes another database including items comprising a list of sample web pages. This is essentially a database including a list of a relative small set of web pages intended to be used for selecting an optimised model to be subsequently used for evaluation (i.e. estimation or prediction) purposes with reference to a generally much broader set of web pages.

The set of sample pages is chosen in such a way that the sample pages represent in a statistically meaningful manner the types of pages for which download performance is to be predicted. For instance, the sample pages in question can be selected as the homepages of 100 most frequently accessed web sites in a certain area.

As already indicated, the measurement database 16 includes the results of those measurements carried out on the network N (essentially throughput and RTT) for each web page in the set of sample pages.

For each sample page subject to measurement, the following items are usually collected and stored:
the page URL,
the size of each object therein,
the start time and the end time of downloading each object,
the total download time,
the throughput and the RTT of the network at the terminal during the time interval where the measurement was carried out (the time interval is chosen judiciously in such a way that no appreciable variations take place in the network parameters while measurements are being carried out),
type and version of the browser used.

After being populated, the database 16 is used for calibrating the free parameter(s) in the evaluation (i.e. estimation or prediction) model.

As indicated, such a model may typically comprise the sum of:
at least one first factor determined analytically on the basis of network and web page parameters, and
a second factor being a function, preferably of the hyperbolic type, of an optimisation parameter.

Such a model is typically represented by a relationship of the type:

$$t = ( \frac{nd}{b} ) + ( \frac{nh}{b} + 2 l + \frac{( n - 1 ) l}{λ} ) \qquad ( I )$$

where t is the total download time of the page, n is the number of objects therein, d is the average size of these objects, b is the throughput of the downstream link (downlink), h is the dimension of the HTTP headers, l is the network RTT.

For a given set of values for n, d, b, h, and l the relationship in question does in fact represent a class or set of models, the various models in the set being characterized by a respective value of the parameter λ.

Calibrating the free parameter(s) in the evaluation model on the basis of the sample web pages essentially requires identifying a value for the parameter λ that corresponds to an “optimum” model, i.e. a model best matching the input-to-output relationships that are actually measured in respect of the sample web pages.

Those of skill in the art will promptly appreciate that:
the models out of which the “optimum” model is selected (based on the measurements carried out on the sample web pages) may in fact correspond to a plurality of different relationships, including heuristic models, and
the “free” parameters involved in the optimisation process may be any number, and not just one (i.e. λ) as in the exemplified case.

Obviously, increasing the number of parameters involved in the optimisation process, will lead to a more complex, resource- and time-consuming optimisation process.

The experiments carried out by the Applicants have however shown that, at least insofar as existing GPRS networks are concerned, the simple relationship (I) reported in the foregoing and involving only one “free” parameter (namely λ) leads to quite satisfactory results.

In general, different types of models are used for evaluating download times and efficiency indexes for different types of network N.

The model to be actually used for a specific case will be selected depending on the type of network considered.

In fact, each model includes approximations that apply only for certain network types. Consequently, it is necessary to measure certain network parameters (essentially the available bandwidth and the RTT) and then select on the basis of pre-determined thresholds, the model best suited for determining the download times of HTTP pages on such a network.

The measurement tool for the download time provided in the processing unit 12 measures the time needed for downloading a given web page by reproducing the behaviour of certain predefined type of web browser, for instance Internet Explorer®.

As its input, the tool in question accepts a list of web pages to be downloaded. As its output, for each web page, the following data are provided:
total download time,
dimension of each object downloaded,
start and end times of downloading each object downloaded.

The results of measurements are stored in the database 16.

In the presently preferred embodiment, a specific tool (currently available with the applicant as BMPOP) is used for downloading pages and deriving the respective download times in co-operation with a “sniffer” for obtaining the dimensions and the download start and end times for each object.

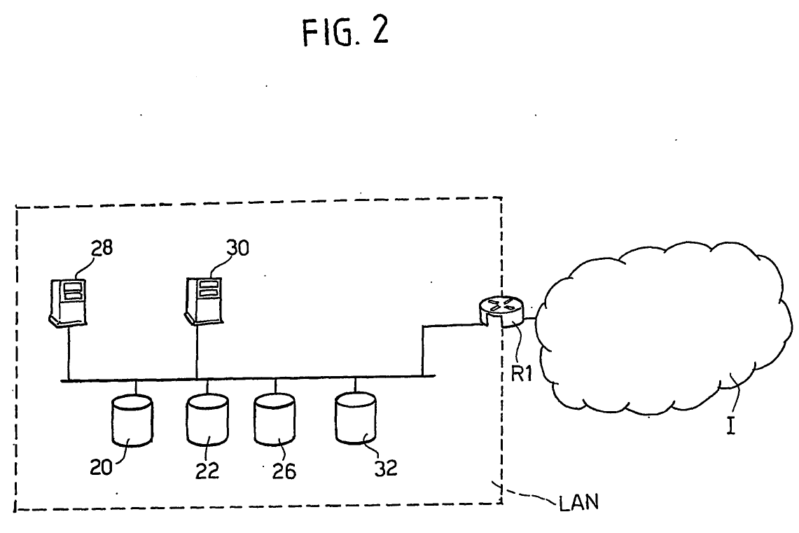

In the diagrams of FIGS. 1 and 2, reference 20 designates the database comprising data base items that define the model to be optimised for predicting the download time of a given web page.

As its input, the database 20 accepts data such as network throughput and RTT, the dimensions of each object included in the web page and one or more free parameters defined experimentally. As its output, the database 20 provides the download time for a given page and/or its efficiency factor, as defined previously.

For instance, this may occur (with reference to existing GPRS networks) on the basis of the relationship (I) considered in the foregoing, where:
t is the total download time of the page (i.e. the output of the model), and
n is the number of objects in the page, d is the average size of its objects, b is the throughput available in the downstream link, h is the dimension of the HTTP headers, l is the network RTT (i.e. the set of input data to the model), and
λ is a factor (parameter) to be established experimentally to identify the “optimum” model to be used for evaluation purposes.

Reference 22 denotes a further database (that in fact may be incorporated with the database 20) including the optimum parameters for the models computed for each combination of network parameters and browser type.

In fact, the arrangement shown herein lends itself to be operated in such a way that the optimum parameter(s)—e.g. λ—are determined for a given model type and for a given network type by measuring the download times of the set of sample pages and then obtaining the best value for the parameter(s), that are stored in the database 22. Then the optimum parameter(s)—e.g. λ—are determined for one or more network types in respect of given models (identical or different from the one considered), by measuring the download times of the set of sample pages and then obtaining the best value for the parameter(s) in the database 22. The database 22 is thus populated with different optimum values to be used for evaluating tasks related to different types of networks.

Optimisation of each model for a given type of network (e.g. finding the value of λ that identifies the optimum model in the set expressed by the mathematical relationship (I) referred to in the foregoing) is performed by an optimiser module 24.

Input data to the module 24 are preferably:
the type of model to be used (e.g. the relationship (I) repeatedly cited in the foregoing),
throughput and RTT of the network considered (e.g. “b” and “l” in the relationship (I)),
list of the web pages,
for each page in the list: the start and end downloading times (whose difference is the parameter “t” in the relationship (I)) and the dimensions of all the objects comprising such a page (e.g. “n”, “h” and “d” in the relationship (I)).

The output of the module 24 is comprised of the optimum value(s) for the free parameter(s) of the model being used ((e.g. “λ” in the relationship (I)).

Specifically, the module 24 operates by allotting a given value to the or each free parameter in the model (e.g. “λ”) and then computing the download times of the pages in the sample set on the basis of such value.

A comparison is then made with the corresponding download times as measured experimentally and a “global” error is then computed as a function of the “partial” errors for each page.

This may be done by resorting to statistical criteria such as e.g. the root means square (RMS) error or the peak value of the signal-to-noise ratio (PSNR).

The value of the free parameter(s) is then varied searching for the minimum of the global error.

This result is preferably achieved in a numerical manner, e.g. by means of a standard numerical method (e.g. steepest descent) aiming at minimising the global error or reducing it below a predetermined value.

Preferably, the server(s) 14 as well as the databases 16, 18, 20, 22 and the module 24 are jointly configured in the form of a local area network (LAN).

The databases 20 and 22 are intended to co-operate with additional databases and other modules in evaluating the download performance for a given set of web pages on the basis of the optimum model identified in the foregoing.

In FIG. 2, reference 26 denotes still another database including the statistical characteristics of a list of web pages for which download performance is to be evaluated.

Specifically, for each web page the following items are stored:
URL,
list of the objects comprised in the page,
dimension of each object.

This database is populated by means of a web site analyser 28 and is subsequently used for determining the download times of the pages contained therein.

The web site analyser 28 is another module adapted to derive the characteristics of the web page to be used as the input for a download performance predictor 30.

The input to the web site analyser 28 is comprised of a list of web pages to be analysed.

The output from the analyser 28 is comprised, for each page in the input list, of the following items:
the list of the object comprising the page, and
the dimensions of each object.

Such an output is stored in the database 26.

Typically, the web site analyser 28 is operated on a fast network, thus making it possible to collect information concerning a large number of web pages in a short time.

The predictor 30 is comprised of a module adapted for calculating the download time and the efficiency index for a given web page without actually performing any measurement.

The predictor 30 is essentially a software module adapted to receive as its input data such as the network characteristics, the browser type used and the characteristics of the web page while providing as its output the download time and the efficiency index evaluated for that page.

In a preferred embodiment, the predictor 30 accepts as its input the following items:
throughput and RTT of the network considered;
model and free parameter(s) of the model i.e. the “optimum” model to be used for evaluating the download performance by way of prediction, and
number and dimensions of the object comprised in the page.

The output of the predictor 30 is comprised essentially of the predicted download time for the page and its efficiency index.

Data pertaining to the characteristics of the page are read from the web page statistics database 26, the parameters to be used are read from the optimised parameter database 22 and the results are written into a prediction database 32.

The efficiency index referred to in the foregoing is preferably determined by resorting to a two-step procedure.

As a first step, the average throughput of each web page is computed by dividing the total number of bytes therein by the download time.

Subsequently, the efficiency index is computed as the ratio of the web page throughput to the network throughput (as measured previously).

In the notional absence of protocol overhead, such an efficiency index would be equal to one.

The database 32 includes the download times and the efficiency indexes evaluated for the web pages included in the list of the web pages to be analysed by means of the “optimum” model defined previously.

The database 32 is populated by the predictor module 30 and it includes the download time and the efficiency index as evaluated for each web page (and for each network type), on the basis of the optimised model. Preferably, for each web page the following items are recorded in the database 32:
download time,
estimated efficiency index,
network parameters (throughput and RTT),
model,
free parameter(s) of the model as used for the prediction.

Consequently, the database 32 will contain (for each of the web pages) the expected download time and the efficiency index on a given type of network.

Again, the various blocks shown in FIG. 2 are preferably configured in order to co-operate in the form of a LAN. In actual fact, the arrangements shown in FIGS. 1 and 2 can be regarded as corresponding to the same LAN being subsequently re-configured to perform two basic processing phases.

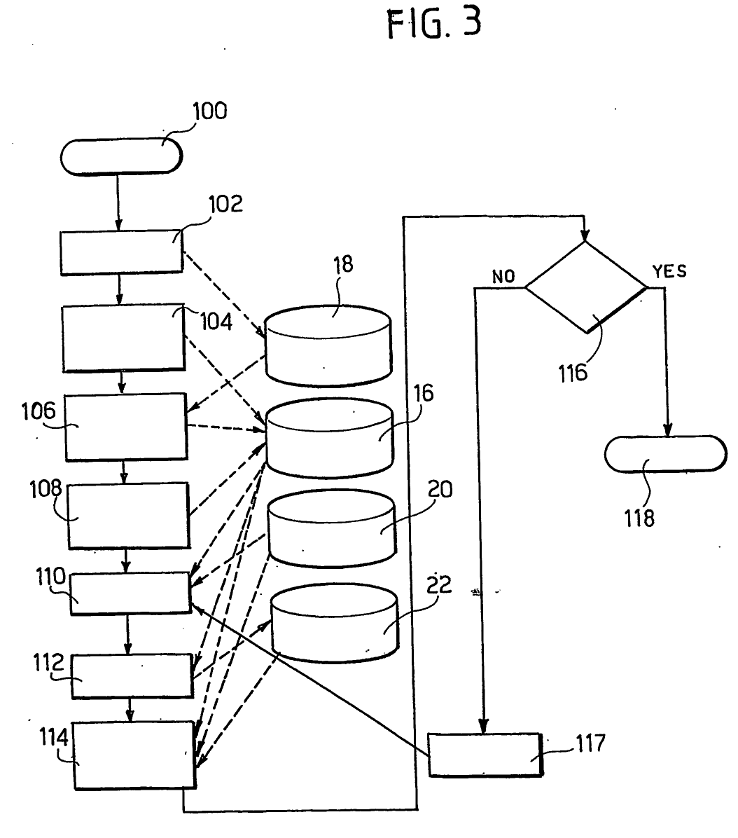

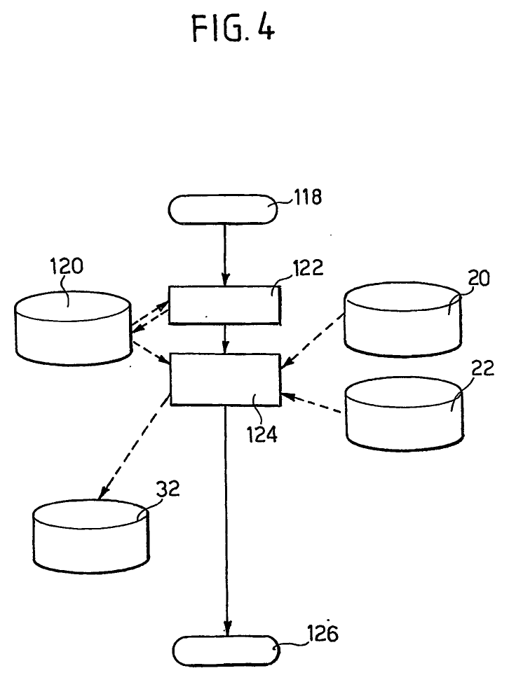

These two phases essentially correspond to the sequence of steps in the flow-charts of FIG. 3 and FIG. 4, respectively.

In the first phase, measurements are carried out on the network N in order to determine the characteristics thereof, while the download times for the sample web pages are measured. The results of such measurements are used for selecting a preferred (“optimum”) model and for setting the free parameters (e.g. λ) of such a model. In the second phase, the model performs prediction by using those parameters.

In the flow-chart of FIG. 3, starting from a step 100, in a step 102 the sample web pages are selected and the respective sample files to be used for carrying out the network measurements are loaded into the reference server(s) 14. These files may be comprised, for instance, of files of different dimensions to be downloaded via HTTP. The information pertaining to the sample web pages thus selected is stored in the database 18.

In a step 104, throughput and RTT are measured for the network by accessing the reference server(s) 14. These measurements are performed by using the tools available in the computer 12 and the respective results are written in the measurement database 16.

It will be appreciated that, while represented in a sequential fashion, the steps 102 and 104 (as well as most of the ensuing steps deriving therefrom) can be carried out at least partly simultaneously.

As indicated, the set of sample web pages stored in the database 18 is selected as a statistically meaningful set comprising, for instance, the home pages of the most frequently accessed websites in a certain area. Essentially, this choice is carried out in such a way that the selected sample web pages will not be appreciably different from the web pages to which the expected predictions will apply. The statistical analysis of the sample web pages is carried out in a step designated 106 and the list of the sample web pages is given as input to the measurement tool for the download times of the web pages.

This tool performs in a step 108 the respective measurements of the download times for the sample web pages. The page statistics (for instance dimensions and number of objects included therein) and the results are stored in the measurement database 16.

In step 110 a candidate model (such as, for instance, the relationship I considered in the foregoing) is selected from the model database 20.

This is preferably done depending on a certain predetermined threshold concerning the network parameters. For instance, if the measurements have been performed on a low throughput network, a model is selected where the server processing times are neglected. Conversely, if a high throughput network is being considered, a model taking into account also those processing times will have to be chosen.

In step 112 the optimiser module 24 is activated in order to process the data comprised of the measurement results and the type of model chosen. The purpose of optimisation is to derive one or more optimum parameters (i.e. the optimum model) for the set of sample pages chosen to be memorized in the parameter database 22. The optimum parameter(s) thus obtained can be subsequently used for predicting, via the module 30, the download times for each page on the same type of network.

For instance, assuming the model is represented by the relationship (I) referred to in the foregoing, the purpose of optimisation is to identify an optimum value of the parameter λ that minimises or reduces below a predetermined value the difference (error) between the download times for the sample pages as actually measured and as evaluated by way of prediction using the model, respectively.

Such an optimisation process may be repeated for different types of networks for which download performance is intended to be evaluated, so that optimum models can be obtained and stored for different types of network to be subsequently analysed.

The download times predicted are compared to the corresponding download times as actually measured for those pages to define a global error associated with the model/parameters under test.

As indicated, the global error is defined as an entity (e.g. MSE, PSNR) indicative of the difference between the predicted values and the values measured over the whole set of the sample web pages.

The optimisation process is thus of iterative nature.

The step 114 is representative of the calculation of the global error on the basis of the optimised parameters. In fact, the step 114 may be regarded as representative of the global error calculated in the final iteration of the optimisation process of the step 112.

In a comparison step 116 the global error in question is compared with a fixed threshold adapted to be defined empirically. If the comparison test is not passed (i.e. the global error is higher than the threshold), a substantial likelihood exists that the model used is not by itself a correct one: for instance a model has been chosen that does not take into account the processing times at the web server, while a “fast” (i.e. a high throughput) network is considered, whereby the processing times in question must be accounted for in the model in order to obtain satisfactory results.

In that case (negative outcome of the step 116) the system evolves via a return step 117 to the selection step 110, which leads to a new type of model being selected.

The whole optimisation process is thus repeated with the aim of obtaining a lower global error.

A positive outcome of the test of step 116 indicates that the global error obtained on the basis of the optimised model (e.g. in the case of the relationship I referred to in the foregoing, an optimised value for λ giving the minimum global error) is acceptable.

The system thus evolves to a step 118, which represents the beginning of the second phase represented by the flow-chart of FIG. 4.

In such a second phase, the download performance (e.g. the download times and the efficiency indexes) is evaluated for a selected set of pages (use pages). This is done in a non-intrusive manner, by way of prediction, using the optimised model defined in the previous phase

In a step 120 the data base items comprising the list of the selected pages or use pages is read from the database 26 and in a step 122, the site analyser 28 is activated. The site analyser 28 is currently operated on a fast network in order to obtain in a short time statistics data related to a large number of pages.

For each page in the set of the selected web pages, the analyser 28 determines the list and the dimensions of the respective objects to be determined. These items are memorised in the statistics database 26.

In a subsequent step 124 the predictor 30 is activated so that the total download time and the efficiency index are determined for each page in the list. The data concerning the pages are read from the statistics database 26, while the model/parameters to be used by the predictor are read from the respective databases 20 and 22.

The results are stored in the prediction database 32, and the system then evolves to a final step 126.

The final result is an evaluation of the download times (and the efficiency indexes) for a selected number of pages among those accessible, and thus downloadable, via the network N.

It will be appreciated that the download times (and the efficiency indexes) evaluation can be a useful tool both for
service providers in order to permit them to realise web pages having download times corresponding to the user requests; and
network operators in order to permit them to now download times in a non-intrusive way.

While the number is these pages may be very high; the download performance data can be evaluated by way of prediction in a short lapse of time. This takes place without interfering in any way with operation of the network N by using an optimised model defined on the basis of a set of sample pages including a relatively small number of sample pages (e.g. the home pages of the 100 most visited sites) that are statistically homogeneous with the pages whose download performance is to be evaluated.

Of course, without prejudice to the underlying principle of the invention, the details and embodiment may vary, also significantly, with respect to what has been described by way of example only, without departing from the scope of the invention as defined by the annexed claims.

1-23. (canceled)

24. A method for evaluating download performance of web pages accessible via a network comprising the steps of:
providing at least one model for predicting a set of download performance parameters for said web pages, said at least one model including at least one optimisation parameter;
defining a set of same web pages;
measuring said set of download performance parameters for said sample web pages;
evaluating said set of download performance parameters for said sample web pages on the basis of said model for different values of said at least one optimisation parameter;
defining an error indicative of the difference between said set of download performance parameters for said sample web pages as measured and as evaluated on the basis of said model, respectively;
selecting an optimised model including a value of said at least one optimisation parameter in order to reduce said error below a predetermined value;
selecting a set of use web pages; and
evaluating said set of download performance parameters for said selected set of use web pages on the basis of said optimised model.

25. The method of claim 24, wherein said set of download performance parameters comprises at least one parameter selected from a group:
download time for a given web page, and
an efficiency index indicative of how said given web page exploits the capacity of said network.

26. The method of claim 24, wherein said at least one model includes at least one parameter selected from a group:
the throughput of said network,
the round trip time of said network, and
at least one of the type and size of each object included in said web pages.

27. The method of claim 24, wherein said sample web pages are selected as a statistically meaningful set of the web pages available for downloading via said network.

28. The method of claim 24, wherein said at least one model is selected by taking into account at least one threshold related to operational parameters of said network.

29. The method of claim 28, comprising the steps of providing in said network at least one server having a respective processing time and said at least one threshold is a function of said processing time.

30. The method of claim 24, further comprising the steps of:
defining, for each sample page in said set of sample pages, a partial error indicative of the difference between said set of download performance parameters for said sample web pages as measured and as evaluated on the basis of said model, respectively;
determining from the partial errors defined for each sample page in said set of sample pages a global prediction error; and
selecting said optimised model including a value of said at least one optimisation parameter minimising said global prediction error.

31. The method of claim 30, comprising the steps of defining said global prediction error as one of a mean value and a peak value of the partial errors defined for each sample page in said set of sample pages.

32. The method of claim 24, comprising the step of providing different types of said at least one model for different types of said network.

33. A method of evaluating download times of web pages accessible via a network, comprising the steps of:
evaluating said download times on the basis of at least one model comprising a module for evaluating the sum of:
at least one first factor determined analytically on the basis of network (b, 1) and web page (n, d, h) parameters; and
a second factor being a function of an optimisation parameter (λ).

34. The method of claim 33, wherein said second factor is a function of hyperbolic type.

35. The method of claim 26 or claim 33, wherein said at least one model corresponds to the following relationship:
$$t = ( \frac{nd}{b} ) + ( \frac{nh}{b} + 2 l + \frac{( n - 1 ) l}{λ} )$$
where t is the total download time of the page, n is the number of objects therein, d is the average size for its objects, b is the downstream throughput, h is the dimension of the HTTP headers, l is the network round trip time and λ is said at least one optimisation parameter.

36. A system for evaluating download performance of web pages accessible via a network, comprising:
first data base items defining at least one model for predicting a set of download performance parameters for said web pages, said at least one model including at least one optimisation parameter;
second data base items defining a set of sample web pages;
measuring tools for measuring said set of download performance parameters for said sample web pages;
a predictor for evaluating said set of download performance parameters for said sample web pages on the basis of said model for different values of said at least one optimisation parameter;
an optimiser module for defining an error indicative of the difference between said set of download performance parameters for said sample web pages as measured and as evaluated on the basis of said model, respectively, said optimiser module being configured for selecting an optimized model including a value of said at least one optimisation parameter able to reduce said error below a predetermined value; and
third data base items indicative of a selected set of use web pages,
said predictor being configured for evaluating said set of download performance parameters for said selected set of use web pages on the basis of said optimised model.

37. The system of claim 36, wherein said set of download performance parameters comprises at least one parameter selected from a group:
download time for a given web page, and
an efficiency index indicative of how said given web page exploits the capacity of said network.

38. The system of claim 36, wherein said at least one model comprises at least one parameter selected from a group:
the throughput of said network,
the round trip time of said network, and
at least one of the type and size of each object included in said web pages.

39. The system of claim 36, wherein said second data base items are configured for defining sample web pages comprising a statistically meaningful set of the web pages available for downloading via said network.

40. The system of claim 36, wherein said optimiser module is configured for:
defining, for each sample page in said set of sample pages, a partial error indicative of the difference between said set of download performance parameters for said sample web pages as measured and as evaluated on the basis of said model, respectively;
determining, from the partial errors defined for each sample page in said set of sample pages, a global prediction error; and
selecting said optimised model including a value of said at least one optimisation parameter minimising said global prediction error.

41. The system of claim 40, wherein said optimiser module is configured for defining said global prediction error as one of a mean value and a peak value of the partial errors defined for each sample page in said set of sample pages.

42. The system of claim 36, wherein said first data base items are representative of different types of said at least one model for different types of said network.

43. A system for evaluating download times of web pages accessible via a network, comprising:
data base items defining at least one model for evaluating said download times, said model comprising a module for evaluating the sum of:
at least one first factor determined analytically on the basis of network (b, 1) and web page (n, d, h) parameters; and
a second factor being a function of an optimisation parameter (λ).

44. The system of claim 43, wherein said second factor is a function of hyperbolic type.

45. The system of claim 38 or claim 43, wherein said at least one model corresponds to the following relationship:
$$t = ( \frac{nd}{b} ) + ( \frac{nh}{b} + 2 l + \frac{( n - 1 ) l}{λ} )$$
where t is the total download time of the page, n is the number of objects therein, d is the average size for its objects, b is the downstream throughput, h is the dimension of the HTTP headers, l is the network round trip time and λ is said at least one optimisation parameter.

46. A computer program product directly loadable into the memory of a computer and including software code portions for performing the steps of any one of claims 24 to 34 when the product is capable of being run on a computer.

47. A computer program product directly loadable into the memory of a computer and including software code portions for performing the steps of claim 35 when the product is capable of being run on a computer.
